(19) United States
(12) Patent Application Publication
(10) Pub. No.: US 2008/0060460 A1
(43) Pub. Date: Mar. 13, 2008

(54) PROPULSION DEVICE EMPLOYING CONVERSION OF ROTARY MOTION INTO A UNIDIRECTIONAL LINEAR FORCE

(76) Inventor: David S. Smith, Ann Arbor, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/670,441

(22) Filed: Feb. 2, 2007

Related U.S. Application Data
(63) Continuation of application No. 10/631,194, filed on Jul. 31, 2003, now abandoned.

(51) Int. Cl. F16H 27/04

(52) U.S. Cl. 74/84 R

(57) ABSTRACT

A mechanism for inducing non-reactive linear motion of a body employs a motor acting through a drive mechanism to rotate a pair of radial arms in counter-rotating directions, synchronously, about a central axis. A gear is rotatably supported about an axis normal to the plane of rotation of the arms, at the outer end of each arm. These two gears are weighted at points on their peripheries and the two gears are in mesh with identical, nonweighted fixed gears supported about the central axis, so that the weighted gears undergo one full rotation for each rotation of the arms. During each rotation of the arms, they experience two alignments, at two radially opposed positions. In one of the positions, the weighted segments are aligned so as to be positioned away from the central axis. At the other alignment position of the arms, the weighted segments are positioned close to the central axis. The unbalanced rotation of the arms and their weighted gears causes a centrifugal pulse in the direction of the most outward position of the rotating gears, moving the entire mechanism along a slide into abutment with a stop at one end of the mechanism to produce a net propulsive force. Rotation of the fixed gears 180 degrees reverses the thrust.

### CROSS-REFERENCE TO RELATED APPLICATIONS

This Application is a Continuation of application Ser. No. 10/631,194 filed on Jul. 31, 2003.

### BACKGROUND OF THE INVENTION

This invention relates to devices which utilize the centrifugal forces produced by rotating masses to produce a single unbalanced propulsive force acting in one direction, so as to provide unidirectional linear motion to a supporting vehicle, and more particularly, to such a system comprising a number of radial arms rotatable about a common axis which arms carry unbalanced weights at their ends which also rotate about axes parallel to the common axis and are aligned when the arms are super-imposed.

### Prior Art

Devices to produce a non-reactive propulsion force, e.g., not acting against a medium or ejecting mass, for vehicles such as automobiles and space carriers have been proposed which rotate masses about a central axis so as to produce centrifugal forces and incorporate means for converting the centrifugal forces into linear forces. Patents on these devices are currently classified by the U.S. Patent and Trademark Office in class 74/845. In one form of such device, a pair of radial arms are rotated synchronously in opposed direction to produce counter-balancing centrifugal forces. These arms are in overlaying, super-imposed relationship twice during each full 360° rotation and means are provided for maximizing the centrifugal forces at one super-imposed position and minimizing the centrifugal forces at the other super-imposed position, so as to provide a net linear force acting in only one direction on the central axis.

U.S. Pat. No. 3,968,700 to Kuff produces unidirectional linear force on the system by providing weights which slide along the length of radial arms projecting from a common axis as the arms rotate. The centrifugal forces produced on the central axis by each mass continuously varies as the masses rotate producing a net centrifugal force parallel to the axis through the points at which the weights attain their maximum and minimum radial distance from the central axis.

U.S. Pat. No. 4,238,968 discloses a similar device employing a pair of radial arms which are rotated in opposing directions about a common axis. One arm contains a mass splitable and transferable to the other arm and back again at 180° intervals. Centrifugal forces are thus imposed on the central axis in the direction of the arc of revolution of the arm which carries both of the masses. The entire rotating mechanism is supported on parallel rails to produce a motion of the device in one direction along the rails.

U.S. Pat. No. 4,631,971 employs a mechanism for driving a pair of symmetrical wheels in opposed directions. Each wheel carries a pair of planetary masses arranged such that their distance from the axis of the rotation of the wheel increases and decreases during rotation. At a position prior to the maximum distance of the planetary masses from the axis, an electromagnetic device restrains outward motion of the planetary mass so that when released the planetary mass provides a whip-like action inducing a resultant force in a direction at right angles to the plane containing the axes of the wheels.

These devices are all complicated and involve mechanisms which produce frictional forces between the various components and accordingly wear over long periods of usage.

### SUMMARY OF THE PRESENT INVENTION

The present invention is accordingly directed toward an improved mechanism for converting centrifugal forces produced during rotary motion into a net linear force. This mechanism which is relatively simple, extremely compact and easily produced, with a very small number of moving parts, is reversible and minimizes the wear produced on the components, being therefore useful for long voyages such as space travel. This mechanism has also been produced in a number of prototypes and has functioned repeatedly and dependably for extended periods of time.

The present invention provides a rotational mechanism preferably supported on one or more rails within a vehicle so that the unbalanced linear motion of the rotational mechanism produces reciprocating translation of the mechanism along the rails. The sliding mounting reduces reciprocating counter force within the device thereby dampening backward oscillatory motion, allowing force to be produced in only one direction. The impact of the rotational mechanism with a stop at one end of the rail will produce a momentum transfer and accordingly a linear unidirectional force will be imposed on the body supporting the mechanism.

The rotational mechanism representing a preferred embodiment of the invention, which will subsequently be disclosed in detail, employs a motor acting through a gear drive mechanism to rotate two radial arms in opposite directions about a common central axis. The arms are spaced along the direction of the common central axis so that they can pass one another without interference. Each arm, toward its radially outer end, supports a stub shaft which extends parallel to the central axis. Each stub shaft carries a gear which is unevenly weighted. Each gear is in mesh with an identical non-weighted stationary gear supported on the central common axis of the rotating arms so that as the arms rotate they cause the two gears to orbit about the central axis in a planetary manner. Since these planetary gears are weighted at one point on their periphery, as they orbit the central axis the radius from the central axis to the centers of mass of the rotating gears varies, with these centers of mass describing or tracing out a heart shaped figure or cardioid. All the gears, fixed or moveable, are identical, having the same size, pitch and numbers of teeth. The counter rotation of the arms and gears also nullifies the effect of torque within the rotational mechanism and entire device.

The counter-rotating radial arms both come into the same angular disposition with respect to the central aspect twice during each full rotation of the arms at two points displaced 180° with respect to one another. The planetary weights on the two arms orbit so that they are in the same radial position with respect to their axes of rotation at the two locations of super-positions of the arms. At one point of super-position both orbiting gears are arrayed so that their centers of mass, or weighted areas, are at a maximum extension from the central axis of the rotating arms; that is the weighted portions lie along the axes of the respective radial arms in a direction away from the central axis. At the radially opposite 180° point of super-position of the two arms, the weighted portions are oriented toward the central axis. This arrangement can be viewed as an effective shifting of the centers of mass of the radial arms as they undergo rotation about their common axis. At their point of super-position where the weights are directed away from the central axis, the centrifigal forces exerted on the central axis are maximized and at the radial opposite super-position the forces are minimized. This produces a force vector in the direction of the maximum radius of the centers of mass, causing motion of the revolving mechanism toward one end of the rails where its slide mounting impacts a stop, transferring the linear momentum of the rotating mechanism to the underlying support vehicle. As the arms continue to rotate, a smaller force vector is produced in the opposite direction, causing retraction of the rotating mechanism along the rails to its initial position. The vectors are also reversible, causing the primary force to be rotated 180 degrees.

### BRIEF DESCRIPTION OF THE DRAWINGS

Other objects, advantages, and applications of the present invention will be made apparent by the following description of a preferred embodiment of the invention. The description makes reference to the accompanying drawings in which:

FIG. 1 is a top view of a non-reactive propulsion device forming a preferred embodiment of my invention;

FIG. 2 is a vertical cross-sectional view through the device of FIG. 1 along line 2-2 of FIG. 3A;

FIG. 3A is a semi-schematic diagram illustrating the overlying position of the rotating arms in which the weighted planetary segments are the maximum distance from the central axis; and

FIG. 3B is a similar schematic representation wherein the rotational arms are at the radially opposed position with the weighted segments at their closest distance to the central axis.

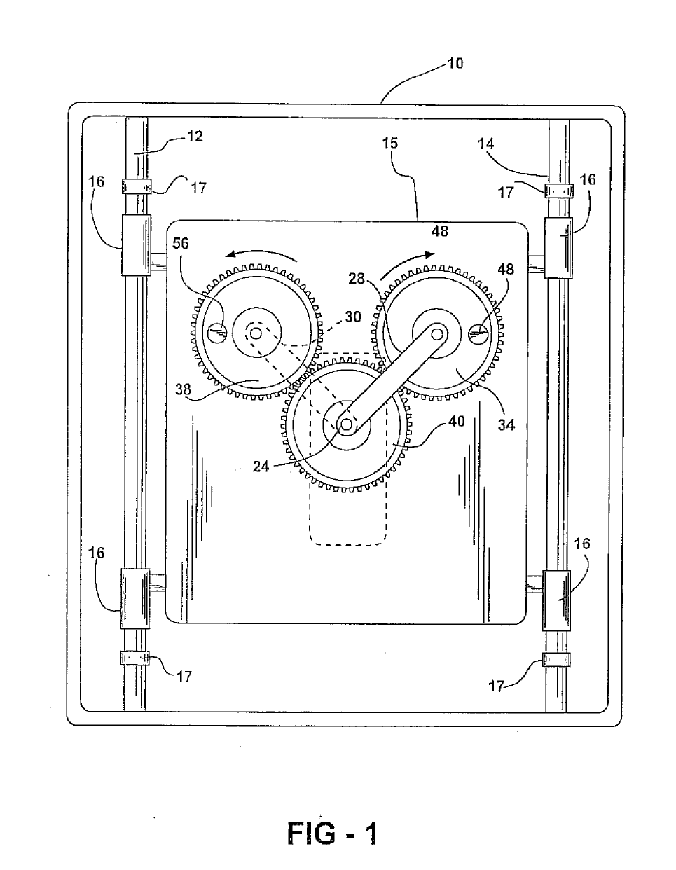

### DETAILED DESCRIPTION

The non-reactive propulsion device of the present invention is illustrated as being supported within a housing 10 having bottom, side walls and an open top. This housing may be attached to a movable vehicle or other structure or may comprise the vehicle itself. By way of example, the housing 10 could be floated on or suspended in (with top enclosed) a body of liquid such as water and the non-reactive propulsive forces developed by the mechanism could propel the housing 10 over or through the liquid. Alternatively, the housing 10 could be part of a space vehicle or the like.

The side walls of the housing 10 support a pair of parallel spaced rails 12 and 14. A slide 15 is supported for sliding motion, back and forth, along the rails 12 and 14 by bushings 16 which engage the side rails. When the rails 12 and 14 are in a horizontal attitude, so that gravity forces do not bias the position of the slide along the rails, the slide 15 may freely move back and forth along the rails when propulsive forces are exerted in either direction parallel to the rails.

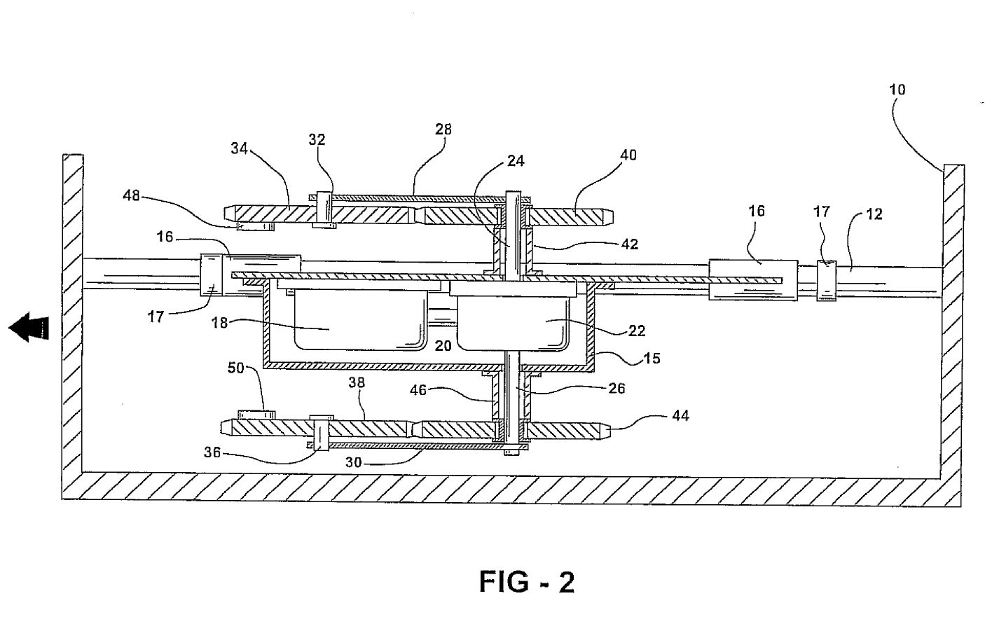

As shown in FIG. 2, the carrier supports a prime mover 18 having a rotating output shaft 20. The prime mover 18 might be an electric motor powered by storage batteries, fuel cells, a nuclear electric power source, solar batteries or the like. The output shaft 20 provides input to a gear box 22 operative to drive a pair of opposed output shafts 24 and 26 in synchronism in opposite directions upon rotation of the input shaft 20. The gear box might incorporate any of a variety of well know mechanisms such as a beveled gear connected to the input shaft 20 driving two gears connected to the output shafts 24 and 26 which gears lie in a plane parallel to the input shaft.

The shafts 24 and 26 each support a radial arm, 28 and 30 respectively, at one end of each shaft, so that the arms rotate in opposed directions about a common axis defined by the shafts 24 and 26. The outer end of the arm 28 carries a stub shaft 32 which rotatably supports a planetary gear 34 so that the gear is free to rotate about an axis parallel to the axis 24. Similarly, the outer end of the arm 30 carries a stub shaft 36 which rotatably supports a second planetary gear 38.

The first planetary gear 34 is in meshing engagement with an identical gear 40 that is centered about the drive shaft 24 but does not rotate with the drive shaft because it is restrained by a strut 42 which is fixed to the gear box 22. Similarly, the second planetary gear 38 is in driving engagement with an identical gear 44 that is fixed against rotation and is centered on the axis of the shaft 26. A strut 46 extending to the gear box 22 fixes the gear 44 against rotation.

Accordingly, when the arms 28 and 30 are rotated in opposing directions by the prime mover 18 acting through the gear box 22, their planetary gears 34 and 38 rotate in a planetary manner about the axis defined by the shafts 24 and 26. The gears 34 and 38 carry weights 48 and 50, respectively, at points on their perimeter. These weights are preferably a major percentage of the weight of the gears 34 and 38.

As the arms 28 and 30 rotate under power from the prime mover, they make the same angle with respect to the central axis defined by the shafts 24 and 26 twice during each rotation. That is, they overlie one another as viewed from the top, which position may be characterized as the position in which there are super-imposed. The gears 34 and 38 are arranged so that in one of these positions of super-position, the two weights 48 and 50, which are also in super-position, are at a maximum distance from the central axis defined by the shafts 24 and 26, and in the other super-imposed position, radially opposite to the first position, the two weights 48 and 50 are at their closest position to the central axis.

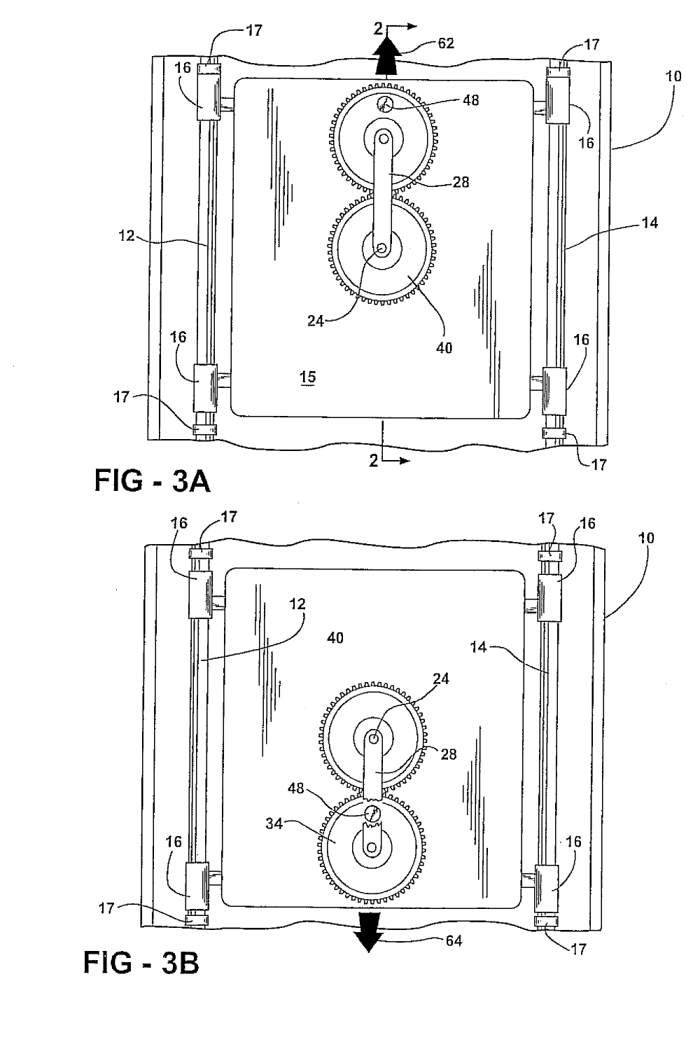

As the arms 28 and 30 rotate about the central axis, and as their offset weighted gears 34 and 38 undergo planetary motion about the central axis, centrifugal forces are imposed on the central axis. Those centrifugal forces are a function of the effective radius of the centers of mass of the two arms and their weighted planetary gears. The weighted segments and/or their centers of mass describe a cardioid as they rotate about the central axis 24 or 26. The centers of mass of the arms vary from a maximum when the arms are super-imposed and their weights 48 and 50 are at maximum distance from the central axis, and a minimum when the arms are super-imposed and the weights are closest to the central axis. This produces a net centrifugal force tending to displace the central axis along the radius from the central axis toward the super-imposed position in which the weights are at a maximum distance from the central axis. FIG. 3A illustrates this position of maximum centrifugal force. FIG. 3B illustrates the opposite super-position of the two arms wherein the weights are closest to the central axis.

This net centrifugal force produces a force vector in the direction of the arrow in FIG. 3A, causing the slide 15 to move along the rails 12 and 14 as the rotating arms approach super-position. The motion of the slide is terminated when stops 17 on the rails abut the slide bushings 16, transferring the momentum of the slide against the container, and urging the container toward motion in the direction of the arrow. As the arms 28 and 30 continue to rotate and approach the position illustrated in FIG. 3B, the slide 16 moves in the opposite direction until it again reverses and begins motion toward the stop in the upper portion of the drawing as the arms continue their rotation. The power pulses in the direction of the arrow 62 in FIG. 3A displaces the slide farther than the secondary pulse in the opposite direction as illustrated by arrow 64 in FIG. 3B. This secondary pulse does not cause movement of the slide carriage 15 sufficient to contact the stops 17 on the bottom of FIG. 3B before the rotation of the arms moves the slide toward the primary pulse location. This results in a continuous series of push/pulses solely in one direction against the carrier. In a frictionless environment, the device will accordingly produce a consistent uniformed acceleration of the member 10.

Various techniques could be provided to produce motion in other directions, such as rotating the fixed gears 180 degrees thereby reversing the force vector, or simply rotating the carrier 15 on the member 10. The rotational speed could also be varied resulting in changes in acceleration and velocity along the principal displacement vector.

Using a small nuclear reactor to power an electric motor acting as the prime 18 would provide virtually unlimited electrical energy to power the system in a space environment. The device could then be used either to alter or move the orbital position of a satellite, or in a propulsion mode at constant acceleration to attain a near-light speed velocity.

Having thus described my invention, I claim:

1. A mechanism comprising:
a pair of arms each rotatably supported at one end along a common axis;
drive means for continuously rotating the arms through full revolutions in opposing directions so that they are super-imposed twice during each full revolution of the arms;
unbalanced masses supported at the radially outer end of each of the arms, for rotation about axes normal to the plane of rotation of the arms;
means for rotating the unbalanced masses about the ends of the arms in timed rotation to the rotation of the two arms about the central axis, so that the unbalanced masses at the ends of both arms are at a maximum distance from the common axis at one point of super-position of the two rotating arms and are at a minimum distance from the common axis at the other point of super-position, resulting in an unbalanced linear force on the common axis.

2. The mechanism of claim 1, wherein the means for rotating the unbalanced mass about the ends of the arms in timed relation to the counter-rotation of the two arms about the central axis, comprises gears rotatably supported at the radially outer end of each of the arms and means for rotating the gears in timed rotation to the rotation of the arms.

3. The mechanism of claim 2, wherein the means for rotating the gears in relation to the rotation of the two arms comprises a fixed gear, centered about the common axis, which meshes with the rotational gears as the arms rotate about the common axis.

4. The mechanism of claim 1, further including one or more rails supporting the rotating arms whereby the unbalanced centrifugal forces produced by the rotation of the arms reciprocates the arms along the rails, against a stop for the rotatable arms located at one end of the travel.

5. A mechanism comprising:
a pair of arms each rotatably supported at one end along a common axis, with the two arms being displaced relative to one another along the axis;
drive means for continuously rotating the arms through full revolutions synchronously in opposing directions so that they assume the same angle with respect to the common axis twice during each full revolution of the arms;
unbalanced masses supported at the radially outer end of each of the arms, for rotation about axes normal to the plane of rotation of the arms;
means for causing the unbalanced masses to rotate in a planetary manner about the common axis in timed relation to the rotation of the arms so that the unbalanced masses rotate once during each full rotation of the arms about the common axis;
the unbalanced masses being supported with respect to the arms and to one another so that at one position in which the arms form the same angular position relative to the common axis the unbalanced masses are at their maximum extension from the common axis along the radial arms, and at the radially opposite position of the elongated arms relative to the common axis the unbalanced masses are at a minimum distance of radial extension from the common axis, whereby the centrifugal forces produced on the common axis are unbalanced in a linear direction.

6. The mechanism of claim 5 wherein the drive means constitutes an electric motor powered by an electric source.

7. The mechanism of claim 6 wherein the electric source constitutes a solar charged battery.

8. The mechanism of claim 6 wherein the electric source constitutes a nuclear charged battery.

9. A drive mechanism for a propulsion device adapted to be supported on a reactive media comprising:
a pair of arms each rotatably supported at one end along a common axis;
drive means for continuously rotating the arms through full revolutions in opposing directions so that they are super-imposed twice during each full revolution of the arms;
unbalanced masses supported at the radially outer end of each of the arms, for rotation about axes normal to the plane of rotation of the arms;
means for rotating the unbalanced masses about the ends of the arms in timed rotation to the rotation of the two arms about the central axis, so that the unbalanced masses at the ends of both arms are at a maximum distance from the common axis at one point of super-position of the two rotating arms and are at a minimum distance from the common axis at the other point of super-position, resulting in an unbalanced linear force on the common axis;
whereby oscillations of the mechanism react with a supporting medium to provide motion of the device along any direction of the unbalanced force on the common axis.

10. The drive mechanism of claim 10, wherein the means for rotating the unbalanced mass about the ends of the arms in timed relation to the counter-rotation of the two arms about the central axis, comprises gears rotatably supported at the radially outer end of each of the arms and means for rotating the gears in timed rotation to the rotation of the arms.

11. The drive mechanism of claim 11, wherein the means for rotating the gears in relation to the rotation of the two arms comprises a fixed gear, centered about the common axis, which meshes with the rotational gears as the arms rotate about the common axis.
